(19) United States
(12) Patent Application Publication
(10) Pub. No.: US 2026/0221692 A1
(43) Pub. Date: Jul. 30, 2026

(54) ELECTRICAL CONNECTOR ASSEMBLY HAVING A CONNECTOR POSITION ASSURANCE DEVICE

(71) Applicants: TE Connectivity Solutions GmbH, Schaffhausen (CH); TE Connectivity Brasil Industria De Eletronicos Ltda., Braganca Paulista (BR)

(72) Inventors: Anton STOYANOV, Winston Salem, NC (US); Rafael A. CAMARGO, Braganca Paulista (BR)

(21) Appl. No.: 19/423,994

(22) Filed: Dec. 17, 2025

Related U.S. Application Data
(60) Provisional application No. 63/751,525, filed on Jan. 30, 2025.
(60) Provisional application No. 63/931,787, filed on Dec. 5, 2025.

(51) Int. Cl. H01R 13/641; H01R 13/627

(52) U.S. Cl. CPC H01R 13/641; H01R 13/627

(57) ABSTRACT

An electrical connector assembly includes an outer housing holding first and second electrical connectors and a CPA. The CPA device is movable between a pre-stage position and a seated position and includes a main body, a first CPA element configured to interface with a first latch and the first electrical connector, and a second CPA element configured to interface with a second latch and the second electrical connector. Movement of the CPA device into the seated position provides a mechanical indication that both the first and second electrical connectors are properly positioned within the outer housing and movement of the CPA device is prevented when at least one of the first and second electrical connectors are not fully inserted in the outer housing.

### CROSS REFERENCE TO RELATED APPLICATIONS

This application claims priority to U.S. application Ser. No. 63/931,787, filed 5-Dec.-2025 and U.S. application Ser. No. 63/751,525, filed 30-Jan.-2025, subject matter of which is herein incorporated by reference in its entirety.

### BACKGROUND OF THE INVENTION

The subject matter herein relates generally to electrical connectors having connector position assurance (CPA) devices.

Electrical connector assemblies used in automotive, industrial, and consumer electronic systems increasingly incorporate multiple electrical connectors grouped within a common outer housing. Such multi-connector arrangements reduce packaging size and simplify routing of wire harnesses by consolidating several individual connectors into a single modular interface. Each of the individual connectors within the housing often includes its own terminal set, latch features, and mating interface for engagement with a corresponding mating connector component.

To ensure proper seating and full engagement of each connector during assembly, many known multi-connector assemblies employ connector position assurance (CPA) devices. Conventional CPA devices are typically associated with a single connector interface and are configured to move between different positions to confirm that a corresponding inner connector is fully inserted into the outer housing. In multi-connector assemblies, this generally results in the use of a separate CPA device for each connector contained within the common housing.

While effective for single-connector applications, the use of multiple independent CPA devices in a shared housing presents several drawbacks. Each CPA must be individually installed, manipulated, and verified during assembly, increasing the total number of manufacturing steps and handling operations. The presence of multiple CPA devices also adds complexity to the assembly workflow, increases part count, and may introduce opportunities for assembly errors if one or more CPA devices are not properly actuated. Furthermore, additional CPA components contribute to increased material cost and require additional space within or on the housing, which may limit design flexibility.

Accordingly, there is a need for improved connector assemblies that incorporate CPA functionality for multiple connectors while reducing the number of parts and assembly steps required to ensure proper connector engagement.

### BRIEF DESCRIPTION OF THE INVENTION

In an embodiment, an electrical connector assembly is provided and includes a first electrical connector for mating with a first mating connector. The first electrical connector includes a first connector housing holding first contacts. The first electrical connector includes a first latching element. The electrical connector assembly includes a second electrical connector for mating with a second mating connector. The second electrical connector includes a second connector housing holding second contacts. The second electrical connector includes a second latching element. The electrical connector assembly includes an outer housing that includes an outer wall surrounding a cavity. The outer housing includes an inner wall dividing the cavity into a first connector chamber receiving the first electrical connector and a second connector chamber that receives the second electrical connector. The outer housing includes a first latch at a first side of the outer housing and a second latch at a second side of the outer housing. The first latch configured to be operably coupled to the first latching element to secure the first electrical connector in the first connector chamber. The second latch configured to be operably coupled to the second latching element to secure the second electrical connector in the second chamber. The electrical connector assembly includes a connector position assurance (CPA) device coupled to the outer housing. The CPA device is movable between a pre-stage position and a seated position. The CPA device includes a main body, a first CPA element configured to interface with the first latch and the first electrical connector, and a second CPA element configured to interface with the second latch and the second electrical connector. Movement of the CPA device into the seated position provides a mechanical indication that both the first and second electrical connectors are properly positioned within the outer housing and movement of the CPA device is prevented when at least one of the first and second electrical connectors are not fully inserted in the outer housing.

In another embodiment, an electrical connector assembly configured to be coupled to a panel is provided. The electrical connector assembly includes a first electrical connector for mating with a first mating connector. The first electrical connector includes a first connector housing holding first contacts. The first electrical connector includes a first latching element. The electrical connector assembly includes a second electrical connector for mating with a second mating connector. The second electrical connector includes a second connector housing holding second contacts. The second electrical connector includes a second latching element. The electrical connector assembly includes an outer housing includes an outer wall surrounding a cavity. The outer wall defines an outer profile. The outer housing includes an inner wall dividing the cavity into a first connector chamber receiving the first electrical connector and a second connector chamber that receives the second electrical connector. The outer housing includes a first latch at a first side of the outer housing and a second latch at a second side of the outer housing. The first latch configured to be operably coupled to the first latching element to secure the first electrical connector in the first connector chamber. The second latch configured to be operably coupled to the second latching element to secure the second electrical connector in the second chamber. The electrical connector assembly includes a connector position assurance (CPA) device coupled to the outer housing. The CPA device is movable between a pre-stage position and a seated position. The CPA device includes a main body, a first CPA element configured to interface with the first latch and the first electrical connector, and a second CPA element configured to interface with the second latch and the second electrical connector. Movement of the CPA device into the seated position provides a mechanical indication that both the first and second electrical connectors are properly positioned within the outer housing and movement of the CPA device is prevented when at least one of the first and second electrical connectors are not fully inserted in the outer housing. The outer housing and the CPA device are configured to be received in and pass through an opening in a panel when the CPA device is in the seated position. The CPA device is configured to interfere with and is unable to pass through the opening when the CPA device is in the pre-stage position.

In a further embodiment, an electrical connector assembly is provided and includes a first electrical connector for mating with a first mating connector. The first electrical connector includes a first connector housing holding first contacts. The first electrical connector includes a first latching element. The electrical connector assembly includes a second electrical connector for mating with a second mating connector. The second electrical connector includes a second connector housing holding second contacts. The second electrical connector includes a second latching element. The electrical connector assembly includes an outer housing that includes an outer wall surrounding a cavity. The outer housing includes an inner wall dividing the cavity into a first connector chamber receiving the first electrical connector and a second connector chamber receiving the second electrical connector. The outer housing includes a first latch at a first side of the outer housing and a second latch at a second side of the outer housing. The first latch configured to be operably coupled to the first latching element to secure the first electrical connector in the first connector chamber. The second latch configured to be operably coupled to the second latching element to secure the second electrical connector in the second chamber. The electrical connector assembly includes a connector position assurance (CPA) device coupled to the outer housing. The CPA device is movable between a pre-stage position and a seated position. The CPA device includes a main body, a first CPA element configured to interface with the first latch and the first electrical connector, and a second CPA element configured to interface with the second latch and the second electrical connector. Movement of the CPA device into the seated position provides a mechanical indication that both the first and second electrical connectors are properly positioned within the outer housing and movement of the CPA device is prevented when at least one of the first and second electrical connectors are not fully inserted in the outer housing. The outer housing includes a scannable data matrix. The scannable data matrix is obscured and unscannable when the CPA device is in the pre-stage position. The scannable data matrix is reveled and scannable when the CPA device is in the seated position.

### BRIEF DESCRIPTION OF THE DRAWINGS

FIG. 1 illustrates an electrical connector assembly in accordance with an exemplary embodiment.

FIG. 2 is a perspective view of the electrical connector assembly in accordance with an exemplary embodiment.

FIG. 3 is an exploded, perspective view of the electrical connector assembly in accordance with an exemplary embodiment.

FIG. 4 is a perspective view of the electrical connector assembly showing the CPA device in a pre-stage position in accordance with an exemplary embodiment.

FIG. 5 is a cross-sectional view of the electrical connector assembly showing the CPA device in the pre-stage position in accordance with an exemplary embodiment.

FIG. 6 is a cross-sectional view of the electrical connector assembly showing the CPA device in the pre-stage position with the first and second electrical connectors removed to illustrate the CPA device relative to the outer housing in accordance with an exemplary embodiment.

FIG. 7 is a side view of the electrical connector assembly showing the CPA device in the pre-stage position in accordance with an exemplary embodiment.

FIG. 8 is a side view of the electrical connector assembly showing the CPA device in the seated position in accordance with an exemplary embodiment.

FIG. 9 is a cross-sectional view of a portion of the electrical connector assembly showing the CPA device in the seated position in accordance with an exemplary embodiment.

FIG. 10 is a front view of the electrical connector assembly relative to the panel and the opening showing the CPA device in the pre-stage position in accordance with an exemplary embodiment.

FIG. 11 is a side view of the electrical connector assembly showing the CPA device in the pre-stage position in accordance with an exemplary embodiment.

FIG. 12 is a side view of the electrical connector assembly showing the CPA device in the seated position in accordance with an exemplary embodiment.

FIG. 13 is a perspective view of the electrical connector assembly in accordance with an exemplary embodiment positioned relative to the opening in the panel.

FIG. 14 is a side view of the electrical connector assembly in accordance with an exemplary embodiment partially loaded through the opening in the panel.

### DETAILED DESCRIPTION OF THE INVENTION

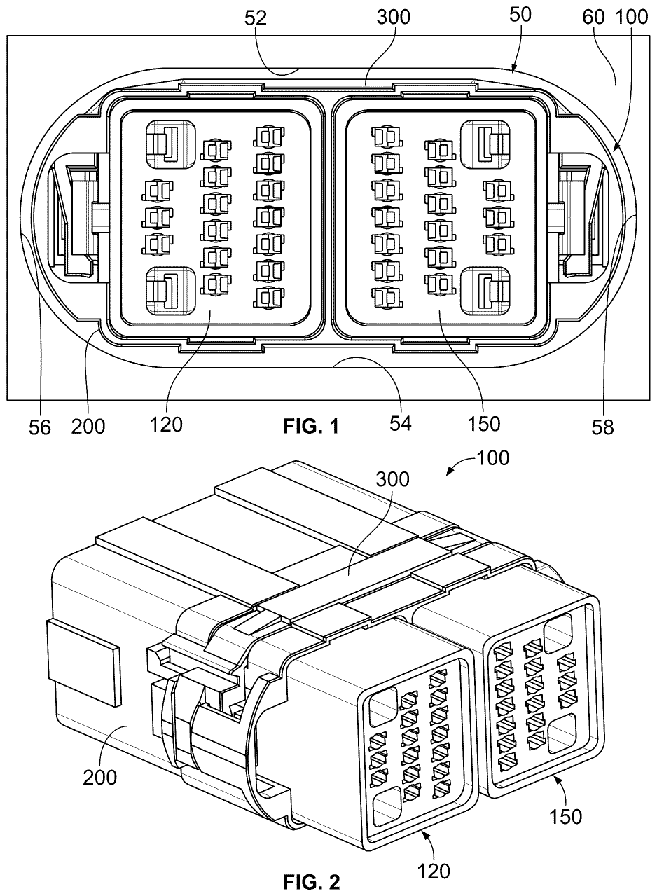

FIG. 1 illustrates an electrical connector assembly 100 in accordance with an exemplary embodiment. The electrical connector assembly 100 may be configured for use in a vehicle. For example, the electrical connector assembly 100 is configured to be mounted at an opening 50 in a panel 60. The panel 60 may be part of a vehicle structure, such as a door panel, body side panel, or any sheet-metal or composite structure through which electrical interfaces must pass.

In an exemplary embodiment, the electrical connector assembly 100 is a multi-connector arrangement having multiple electrical connectors, such as a first electrical connector 120 and a second electrical connector 150, grouped together within a common outer housing 200. In an exemplary embodiment, the electrical connector assembly 100 incorporates a connector position assurance (CPA) device 300 to verify full seating of the electrical connectors 120, 150 within the outer housing 200.

In an exemplary embodiment, the CPA device 300 and the outer housing 200 are configured to fit through the opening 50 in the panel 60 when assembled. For example, the CPA device 300 and the outer housing 200 have a profile that fits through and is configured to pass through the opening 50 during assembly. The outer profile of the CPA device 300 and the outer housing 200 may have a shape that corresponds to the shape of the opening 50. In the illustrated embodiment, the opening 50 is oval shaped having edges at opposite upper and lower ends 52, 54 and opposite sides 56, 58. The upper and lower ends 52, 54 may be straight and parallel to each other. The first and second sides 56, 58 may be curved between the upper and lower ends 52, 54. The opening 50 may have other shapes in alternative embodiments.

The outer housing 200 may include a mounting flange, latching fingers, or other retention features adapted to engage the edges of the panel opening 50 so that the outer housing 200 is held in a fixed position relative to the panel 60. When installed, the outer housing 200 spans the panel opening 50 and provides an interface accessible from the interior or exterior side of the panel 60, depending on application requirements. The electrical connector assembly 100 may also include environmental sealing features, such as perimeter gaskets, wire seals, or moisture barriers, formed around the outer housing 200 or in the interior of the outer housing 200 to prevent water, dust, and debris from entering the panel opening 50.

In various embodiments, the electrical connector assembly 100 may be positioned at a door-to-body interface of a vehicle, where electrical circuits must pass between a movable door and a stationary body structure. In such applications, the outer housing 200 is mounted to the door panel 60 to position the first and second electrical connectors 120, 150 at the door panel 60, while the mating connector is positioned on the vehicle body side. The arrangement allows for a robust and serviceable electrical interface that can withstand repeated door opening and closing cycles, environmental exposure, and mechanical stress. The CPA device 300 ensures that the first and second electrical connectors 120, 150 within the door-side housing remains fully seated and provides reliable electrical continuity as the vehicle operates.

FIG. 2 is a perspective view of the electrical connector assembly 100 in accordance with an exemplary embodiment. FIG. 2 shows the first and second electrical connectors 120, 150 fully inserted into the outer housing 200 and secured in the outer housing 200. FIG. 2 shows the CPA device 300 in a seated position interfacing with the first and second electrical connectors 120, 150 and the outer housing 200. The CPA device 300 is configured to be operably coupled to both the first and second electrical connectors 120, 150. The CPA device 300 may be blocked or prevented from movement when either of the electrical connectors 120, 150 are not fully inserted into the outer housing 200 thus providing position assurance for both the first and second electrical connectors 120, 150 using a single or common CPA component.

The CPA device 300 is movable from a pre-stage position to the seated position only when the first and second electrical connectors 120, 150 are fully inserted into the outer housing 200. For example, the CPA device 300 may be moved inward, such as in a direction perpendicular to the mating direction of the electrical connector assembly 100. When either of the first electrical connector 120 or the second electrical connector 150 are not properly installed, a blocking feature of the CPA device 300 interferes with a corresponding surface of the outer housing 200, thereby preventing movement of the CPA device 300 into the seated position. Once the first and second electrical connectors 120, 150 reach their intended depth, latching elements of the outer housing 200 and the electrical connectors 120, 150 are properly engaged to secure the electrical connectors 120, 150 in the outer housing 200 and removing the blocking condition for the CPA device 300 thus allowing the CPA device 300 to be advanced from the pre-stage position to the seated position. Movement of the CPA device into the seated position provides a mechanical verification that the electrical connectors 120, 150 are properly positioned within the outer housing 200.

In some embodiments, the CPA device 300, when fully actuated, also provides a secondary locking function that prevents inadvertent withdrawal or unlatching of the electrical connectors 120, 150, such as due to vibration, thermal cycling, or mechanical loads encountered during vehicle operation. The CPA device 300 may engage portions of the electrical connectors 120, 150 to restrict reverse movement, or may lock one or more latch arms in an engaged condition.

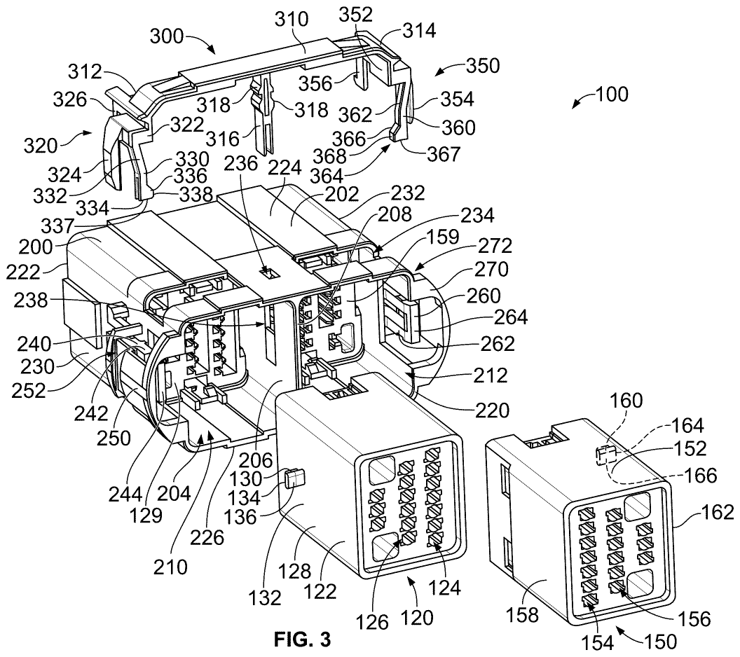

FIG. 3 is an exploded, perspective view of the electrical connector assembly 100 in accordance with an exemplary embodiment. The electrical connector assembly 100 is a multi-connector arrangement having the multiple electrical connectors 120, 150 arranged within a single, common outer housing 200. The CPA device 300 is a multi-connector CPA device configured to be operably coupled to the multiple electrical connectors 120, 150 to provide proper connector position assurance for the multiple electrical connectors 120, 150 using a single, common CPA component.

The first electrical connector 120 is separate and discrete from the second electrical connector 150. The first and second electrical connectors 150 may be similar to each other, or identical to each other, and like components are identified with like reference numerals. The first electrical connector 120 may provide signal and/or power connections with a corresponding mating electrical connector. Similarly, the second electrical connector 150 may provide signal and/or power connections with a corresponding mating electrical connector. The electrical connector assembly 100 may include additional electrical connectors (not shown), such as a third electrical connector located between the first and second electrical connectors 120, 150.

The first electrical connector 120 includes a first connector housing 122 holding first contacts 124. The first contacts 124 may be terminated to ends of wires (not shown). The first contacts 124 may be arranged in contact channels 126 passing through the first connector housing 122. In various embodiments, the first connector housing 122 is a multipiece housing having a front housing 128 and a rear housing 129. The front housing 128 holds the first contacts 124 and may be assembled through a front of the outer housing 200. The rear housing 129 may hold the wires and may be assembled through a front or a rear of the outer housing 200. In an exemplary embodiment, the CPA device 300 is configured to interface with the front housing 128 to assure proper loading of the front housing 128 into the outer housing 200.

In an exemplary embodiment, the first electrical connector 120 includes a first latching element 130 extending from a side 132 of the first connector housing 122. The first latching element 130 extends to a distal end 134. The first latching element 130 includes a latching surface 136, such as at a front surface of the first latching element 130. In an exemplary embodiment, the latching surface 136 is configured to interface with a latching element of the outer housing 200 to latchably secure the first electrical connector 120 in the outer housing 200. In an exemplary embodiment, the distal end 134 is configured to interface with a portion of the CPA device 300 to release the CPA device 300 and allow the CPA device 300 to move from a pre-stage position to the seated position when the first electrical connector 120 is fully inserted into the outer housing 200.

The second electrical connector 150 includes a second connector housing 152 holding second contacts 154. The second contacts 154 may be terminated to ends of wires (not shown). The second contacts 154 may be arranged in contact channels 156 passing through the second connector housing 152. In various embodiments, the second connector housing 152 is a multipiece housing having a front housing 158 and a rear housing 159. The front housing 158 holds the second contacts 154 and may be assembled through a front of the outer housing 200. The rear housing 159 may hold the wires and may be assembled through a front or a rear of the outer housing 200. In an exemplary embodiment, the CPA device 300 is configured to interface with the front housing 158 to assure proper loading of the front housing 158 into the outer housing 200.

In an exemplary embodiment, the second electrical connector 150 includes a second latching element 160 (shown in phantom) extending from a side 162 of the second connector housing 152. The second latching element 160 extends to a distal end 164. The second latching element 160 includes a latching surface 166, such as at a front surface of the second latching element 160. In an exemplary embodiment, the latching surface 166 is configured to interface with a latching element of the outer housing 200 to latchably secure the second electrical connector 150 in the outer housing 200. In an exemplary embodiment, the distal end 164 is configured to interface with a portion of the CPA device 300 to release the CPA device 300 and allow the CPA device 300 to move from a pre-stage position to the seated position when the second electrical connector 150 is fully inserted into the outer housing 200.

The outer housing 200 is configured to receive the electrical connectors 120, 150 and the CPA device 300. In an exemplary embodiment, the outer housing 200 is manufactured from a dielectric material, such as a plastic material. For example, the outer housing 200 may be a molded part. The outer housing 200 includes an outer wall 202 surrounding a cavity 204. The outer housing 200 may include one or more inner walls 206 in the cavity 204. For example, the outer housing 200 includes a central wall 208 that divides the cavity 204 into a first connector chamber 210 and a second connector chamber 212. The first connector chamber 210 is configured to receive the first electrical connector 120 and the second connector chamber 212 is configured to receive the second electrical connector 150. The cavity 204 may be divided into other chambers that receive other electrical connectors in alternative embodiments.

The outer housing 200 extends between a front 220 and the rear 222. The outer housing 200 includes a top 224 and a bottom 226. The outer housing 200 includes a first side 230 and a second side 232. In various embodiments, the outer housing 200 is generally rectangular shaped. For example, the top 224 and the bottom 226 may be generally planar and extend parallel to each other. The first side 230 and the second side 232 may be generally planar and extend parallel to each other. In the illustrated embodiment, the central wall 208 is approximately centered between the first and second sides 230, 232 such that the first and second connector chambers 210, 212 have similar sizes. However, in alternative embodiments, the central wall 208 may be located closer to the first side 230 or the second side 232 to form different size chambers.

In an exemplary embodiment, the outer housing 200 includes a CPA pocket 234 that receives the CPA device 300. The CPA pocket 234 may be located at the top 224 and/or the first side 230 and/or the second side 232. The CPA pocket 234 extends into the outer housing 200 and allows the CPA device 300 to be recessed within the outer housing 200, such as to reduce an overall profile of the electrical connector assembly 100. The CPA pocket 234 may be open through the outer housing 200 to the cavity 204. Such opening may allow portions of the CPA device 300 to extend into the cavity 204.

In an exemplary embodiment, the outer housing 200 includes an opening 236 configured to receive a portion of the CPA device 300. The opening 236 may be aligned with the central wall 208 to allow a portion of the CPA device 300 to extend along the central wall 208. The central wall 208 may include an opening 238 passing therethrough that receives a portion of the CPA device 300. For example, the CPA device 300 may be received in the openings 236, 238 to interface with the first and second electrical connectors 120, 150 when the first and second electrical connectors 120, 150 are loaded into the first and second connector chambers 210, 212.

The outer housing 200 includes a first latch 240 at the first side 230. The first latch 240 is configured to be latchably coupled to the first electrical connector 120, such as to the first latching element 130. In an exemplary embodiment, the first latch 240 is a deflectable latch configured to be released to release the first electrical connector 120 from the outer housing 200. In an exemplary embodiment, the first latch 240 includes a latch arm 242 and a latching finger 244 at a distal end of the latch arm 242 configured to engage the latching surface 136 of the first latching element 130.

In an exemplary embodiment, the outer housing 200 includes a first latch shroud 250 that surrounds a portion of the first latch 240. The first latch shroud 250 may extend outward from the first side 230. In the illustrated embodiment, the first latch shroud 250 has a curvature, which may match a curvature of the opening 50 in the panel 60 (shown in FIG. 1). In an exemplary embodiment, the outer housing 200 includes a first guide track 252 configured to receive a portion of the CPA device 300. In the illustrated embodiment, the first guide track 252 is located in the first latch shroud 250. The first guide track 252 is used to guide movement of the CPA device 300 relative to the outer housing 200.

The outer housing 200 includes a second latch 260 at the second side 232. The second latch 260 is configured to be latchably coupled to the second electrical connector 150, such as to the second latching element 160. In an exemplary embodiment, the second latch 260 is a deflectable latch configured to be released to release the second electrical connector 150 from the outer housing 200. In an exemplary embodiment, the second latch 260 includes a latch arm 262 and a latching finger 264 at a distal end of the latch arm 262 configured to engage the latching surface 166 of the second latching element 160.

In an exemplary embodiment, the outer housing 200 includes a second latch shroud 270 that surrounds a portion of the second latch 260. The second latch shroud 270 may extend outward from the second side 232. In the illustrated embodiment, the second latch shroud 270 has a curvature, which may match a curvature of the opening 50 in the panel 60 (shown in FIG. 1). In an exemplary embodiment, the outer housing 200 includes a second guide track 272 configured to receive a portion of the CPA device 300. In the illustrated embodiment, the second guide track 272 is located in the second latch shroud 270. The second guide track 272 is used to guide movement of the CPA device 300 relative to the outer housing 200.

In an exemplary embodiment, the CPA device 300 is a unitary, single piece component configured to be coupled to the outer housing 200 and interface with the multiple electrical connectors 120, 150 received in the outer housing 200. The CPA device 300 includes a main body 310, a first CPA element 320 extending from a first side 312 of the main body 310, and a second CPA element 350 extending from a second side 314 of the main body 310. The first CPA element 320 is configured to interface with the first latch 240 and the first electrical connector 120. The second CPA element 350 is configured to interface with the second latch 260 and the second electrical connector 150.

In an exemplary embodiment, the CPA device 300 includes a center blocking finger 316 extending from an inner surface of the main body 310. The center blocking finger 316 is configured to be positioned between the first and second electrical connectors 120, 150 and may interface directly with the first and second electrical connectors 120, 150 when the first and second electrical connectors 120, 150 are inserted into the first and second connector chambers 210, 212. In an exemplary embodiment, the center blocking finger 316 is received in the opening 236 and the outer wall 202 to extend into the cavity 204. In an exemplary embodiment, the center blocking finger 316 is configured to be received in the opening 238 in the central wall 208 such that the center blocking finger 316 is positioned in the first connecting chamber 210 and the second connecting chamber 212 to interface with the first and second electrical connectors 120, 150. In an exemplary embodiment, the center blocking finger 316 includes protrusions 318, such as ribs along the opposite sides of the center blocking finger 316. The protrusions 318 are configured to engage the outer housing 200, such as the top wall, to hold the CPA device 300 at various positions. For example, the protrusions 318 may engage the outer wall 202 to hold the CPA device 300 at a pre-stage position. The protrusions 318 may hold the main body 310 at an elevated position above the top wall of the outer housing 200.

In an exemplary embodiment, the main body 310 is located at a top of the CPA device 300. The first and second CPA elements 320, 350 extend downward from the main body 310 at the opposite sides 312, 314 thereof. The main body 310 is configured to be received in the CPA pocket 234, such as along the top 224 of the outer housing 200. The first and second CPA elements 320, 350 may be received in the CPA pocket 234. In an exemplary embodiment, the first and second CPA elements 320, 350 are configured to be received in the first latch shroud 250 and a second latch shroud 270, respectively. The latch shrouds 250, 270 may cover or protect the components of the CPA elements 320, 350.

The first CPA element 320 includes a base 322 and a first engagement feature 330 extending from the base 322. For example, the first engagement feature 330 extends downward from the base 322. In the illustrated embodiment, the first engagement feature 330 is located at a front of the base 322. Other locations are possible in alternative embodiments. The first engagement feature 330 defines a blocking feature of the CPA device 300 configured to interfere with a corresponding surface of the outer housing 200, such as the first latch 240, thereby preventing movement of the CPA device 300 to the seated position. For example, the first engagement feature 330 is movable between an engagement position in the clearance position. In the engagement position, the first engagement feature 330 engages the first latch 240 and holds the CPA device 300 in the pre-stage position. The CPA device 300 is unable to move from the pre-stage position until the first engagement feature 330 is actuated to the clearance position. In an exemplary embodiment, the first engagement feature 330 is configured to interface with the first electrical connector 120 when the first electrical connector 120 is in the fully loaded position to move the first engagement feature 330 to the clearance position. For example, only when the first electrical connector 120 is in the fully loaded position is the blocking condition for the CPA device 300 removed, thus allowing the CPA device 300 to be advanced from the pre-stage position to the seated position.

In various embodiments, the first CPA element 320 includes a first guide finger 324 extending from the base 322 used to guide mating of the first CPA element 320 with the outer housing 200, such as with the first latch shroud 250. For example, the first guide finger 324 may be received in the first guide track 252 to guide movement of the first CPA element 320, such as in a vertical direction. In the illustrated embodiment, the first guide finger 324 is located at an outer end of the first CPA element 320. Other locations are possible in alternative embodiments.

In various embodiments, the first CPA element 320 includes a first latch blocking finger 326 extending from the base 322. The first latch blocking finger 326 is configured to interface with the first latch 240. For example, the first latch blocking finger 326 may be positioned between the first latch 240 and the first side 230 of the outer housing 200 to block actuation of the first latch 240 when the first CPA element 320 is in the seated position. In the illustrated embodiment, the first latch blocking finger 326 is located at the rear of the base 322. Other locations are possible in alternative embodiments.

In an exemplary embodiment, the first engagement feature 330 is configured to interface with a portion of the outer housing 200, such as the first latch 240. The first engagement feature 330 includes a deflectable spring beam 332 that extends from the base 322 to a distal end 334. The first engagement feature 330 includes a blocking tab 336 extending inward from the spring beam 332 at the distal end 334. The blocking tab 336 includes an end surface 337 and an inner surface 338. The end surface 337 of the blocking tab 336 is configured to engage and abut against a portion of the first latch 240 to block movement of the first CPA element 320 relative to the outer housing 200 and the first latch 240. When the end surface 337 of the blocking tab 336 engages the first latch 240, the CPA device 300 is held in the pre-stage position and is unable to move to the seated position. In an exemplary embodiment, the inner surface 338 of the blocking tab 336 of the first engagement feature 330 is configured to interface with the first electrical connector 120 when the first electrical connector 120 is plugged into the first connector chamber 210. For example, the first inner surface 338 of the blocking tab 336 may interface with the first latching element 130 (when the first electrical connector 120 is fully plugged into the first connector chamber 210) and the first latching element 130 deflects the spring beam 332 of the first engagement feature 330 to the clearance position. The end surface 337 of the blocking tab 336 is released from the first latch 240 in the clearance position (for example, the blocking condition is removed) to allow the CPA device 300 to move to the seated position.

The second CPA element 350 includes a base 352 and a second engagement feature 360 extending from the base 352. For example, the second engagement feature 360 extends downward from the base 352. In the illustrated embodiment, the second engagement feature 360 is located at a front of the base 352. Other locations are possible in alternative embodiments. The second engagement feature 360 defines a blocking feature of the CPA device 300 configured to interfere with a corresponding surface of the outer housing 200, such as the second latch 260, thereby preventing movement of the CPA device 300 to the seated position. For example, the second engagement feature 360 is movable between an engagement position and a clearance position. In the engagement position, the second engagement feature 360 engages the second latch 260 and holds the CPA device 300 in the pre-stage position. The CPA device 300 is unable to move from the pre-stage position until the second engagement feature 360 is actuated to the clearance position. In an exemplary embodiment, the second engagement feature 360 is configured to interface with the second electrical connector 150 when the second electrical connector 150 is in the fully loaded position to move the second engagement feature 360 to the clearance position. For example, only when the second electrical connector 150 is in the fully loaded position is the blocking condition for the CPA device 300 removed, thus allowing the CPA device 300 to be advanced from the pre-stage position to the seated position.

In various embodiments, the second CPA element 350 includes a second guide finger 354 extending from the base 352 used to guide mating of the second CPA element 350 with the outer housing 200, such as with the second latch shroud 270. For example, the second guide finger 354 may be received in the second guide track 272 to guide movement of the second CPA element 350, such as in a vertical direction. In the illustrated embodiment, the second guide finger 354 is located at an outer end of the second CPA element 350. Other locations are possible in alternative embodiments.

In various embodiments, the second CPA element 350 includes a second latch blocking finger 356 extending from the base 352. The second latch blocking finger 356 is configured to interface with the second latch 260. For example, the second latch blocking finger 356 may be positioned between the second latch 260 and the second side 232 of the outer housing 200 to block actuation of the second latch 260 when the second CPA element 350 is in the seated position. In the illustrated embodiment, the second latch blocking finger 356 is located at the rear of the base 352. Other locations are possible in alternative embodiments.

In an exemplary embodiment, the second engagement feature 360 is configured to interface with a portion of the outer housing 200, such as the second latch 260. The second engagement feature 360 includes a deflectable spring beam 362 that extends from the base 352 to a distal end 364. The second engagement feature 360 includes a blocking tab 366 extending inward from the spring beam 362 at the distal end 364. The blocking tab 366 includes an end surface 367 and an inner surface 368. The end surface 367 of the blocking tab 366 is configured to engage and abut against a portion of the second latch 260 to block movement of the second CPA element 350 relative to the outer housing 200 and the second latch 260. When the end surface 367 of the blocking tab 366 engages the second latch 260, the CPA device 300 is held in the pre-stage position and is unable to move to the seated position. In an exemplary embodiment, the inner surface 368 of the blocking tab 366 of the second engagement feature 360 is configured to interface with the second electrical connector 150 when the second electrical connector 150 is plugged into the second connector chamber 212. For example, the second inner surface 368 of the blocking tab 366 may interface with the second latching element 160 (when the second electrical connector 150 is fully plugged into the second connector chamber 212) and the second latching element 160 deflects the spring beam 362 of the second engagement feature 360 to the clearance position. The end surface 367 of the blocking tab 366 is released from the second latch 260 in the clearance position (for example, the blocking condition is removed) to allow the CPA device 300 to move to the seated position.

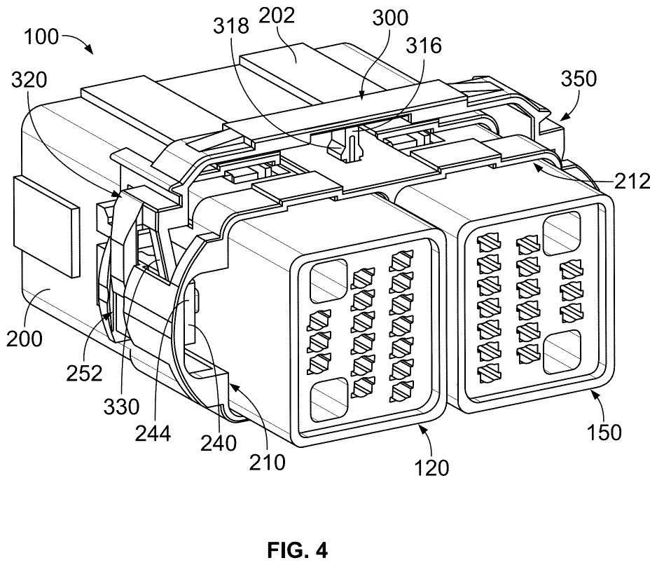

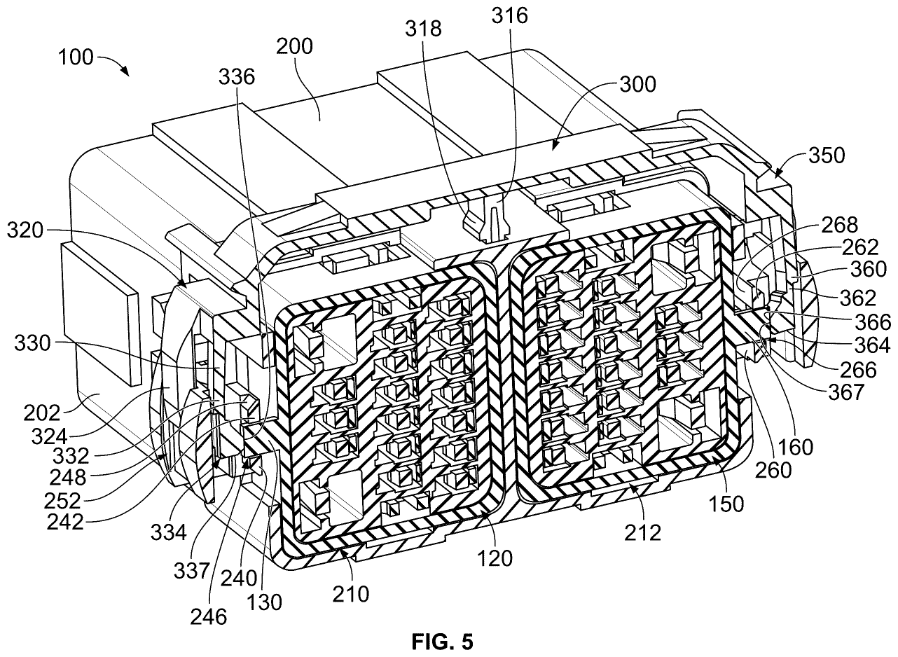

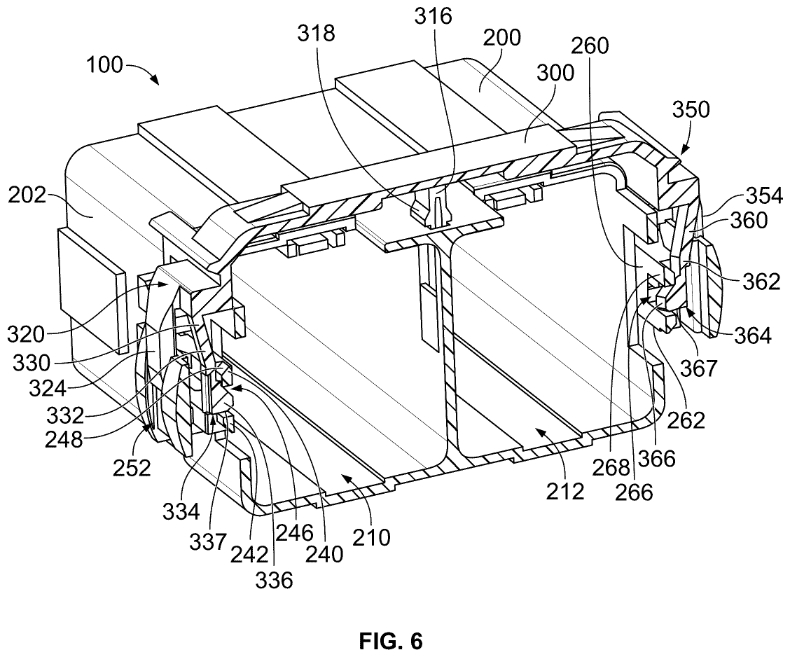

FIG. 4 is a perspective view of the electrical connector assembly 100 showing the CPA device 300 in a pre-stage position. FIG. 5 is a cross-sectional view of the electrical connector assembly 100 showing the CPA device 300 in the pre-stage position. FIG. 6 is a cross-sectional view of the electrical connector assembly 100 showing the CPA device 300 in the pre-stage position with the first and second electrical connectors 120, 150 removed to illustrate the CPA device 300 relative to the outer housing 200.

When assembled, the protrusions 318 along the center blocking finger 316 may engage the outer wall 202 to hold the CPA device 300 at the pre-stage position. When assembled, the first and second CPA elements 320, 350 may engage the outer housing 200 to position the CPA device 300 and/or hold the CPA device 300 at the pre-stage position relative to the outer housing 200. For example, the first and second guide fingers 324, 354 may be received in the first and second guide tracks 252, 272, respectively. The guide tracks 252, 272 guide movement of the guide fingers 324, 354, such as in a vertical direction to control movement of the CPA device 300 from the pre-stage position to the seated position (shown in FIG. 2). In an exemplary embodiment, the first and second engagement features 330, 360 engage the outer housing 200, such as at the first and second latches 240, 260, to hold the CPA device 300 at the pre-stage position. For example, the end surfaces 337, 367 of the blocking tabs 346, 366 engage the first and second latch 240, 260 to hold the CPA device 300 in the pre-stage position. The CPA device 300 is unable to move to the seated position when the engagement features 330, 360 are in the engagement positions (FIG. 6) and engage the outer housing 200 (for example, until the engagement features 330, 360 are moved to the clearance position (FIG. 5)).

In an exemplary embodiment, the first and second latches 240, 260 include latch windows 246, 266 in the latch arms 242, 262. The latch windows 246, 266 are openings having arm portions 248, 268 of the latch arms 242, 262 extending above and below the openings. The latch fingers 244, 264 are located forward of the latch windows 246, 266. The latch windows 246, 266 are configured to receive the first and second latching elements 130, 160 when the first and second electrical connectors 120, 150 are fully loaded into the outer housing 200. When the first and second latching elements 130, 160 are received in the latch windows 246, 266, the latching element 130, 160 are latchably coupled to the first and second latches 240, 260. For example, the latch fingers 244, 264 engage the latching elements 130, 160 and prevent removal of the first and second connectors 120, 150 from the outer housing 200.

When the CPA device 300 is in the pre-stage position, the blocking tabs 336, 366 at the distal ends 334, 364 of the spring beams 332, 362 are received in the latch windows 246, 266 and engage the arm portions 248, 268 when in the engagement positions (FIG. 6). However, when the first and second electrical connectors 120, 150 are fully loaded into the first and second connector chambers 210, 212, the first and second latching elements 130, 160 engage the blocking tabs 336, 366 and press the blocking tabs 336, 366 outward out of the latch windows 246, 266. The first and second latching elements 130, 160 move the first and second engagement features 330, 360 to the clearance positions. The first and second latching elements 130, 160 move the end surfaces 337, 367 of the blocking tabs 346, 366 clear of the arm portions 248, 268 and allow the CPA device 300 to move downward from the pre-stage position to the seated position. Only when both of the engagement features 330, 360 are moved to the clearance position is a CPA device 300 able to move from the pre-stage position to the seated position. For example, if one of the engagement features 330, 360 is in the engagement position (for example, when one of the electrical connectors 120, 150 is not fully loaded into the outer housing 200 and thus the latching elements 130, 160 are not received in the latch windows 246, 266), the CPA device 300 is still blocked from moving from the pre-stage position to the seated position. Only when both of the electrical connectors 120, 150 are fully loaded into the outer housing 200 is the CPA device 300 clear to move to the seated position.

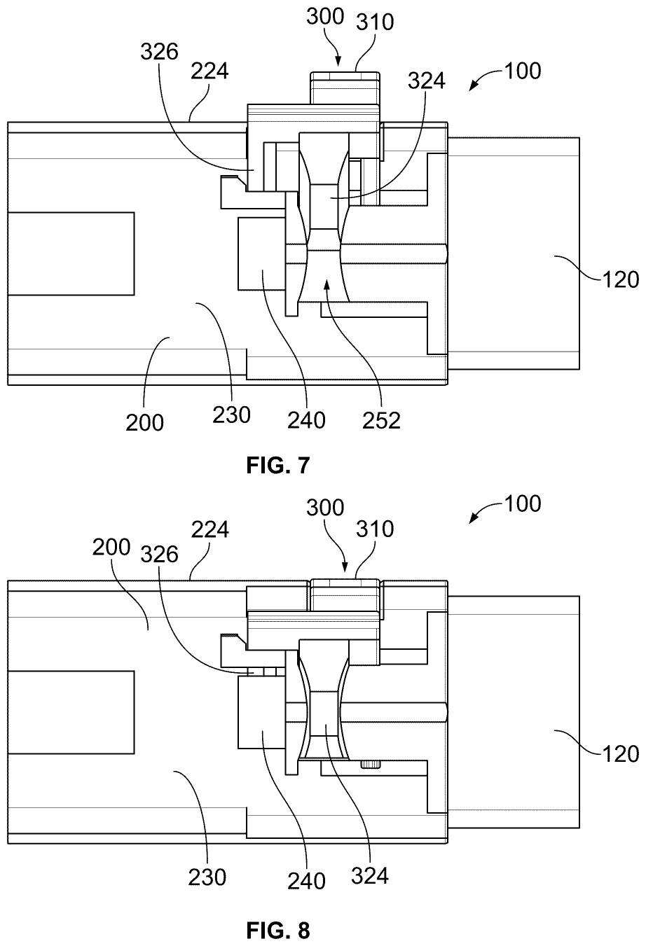

FIG. 7 is a side view of the electrical connector assembly 100 showing the CPA device 300 in the pre-stage position. FIG. 8 is a side view of the electrical connector assembly 100 showing the CPA device 300 in the seated position. In an exemplary embodiment, the guide tracks 252, 272 guide movement of the guide fingers 324, 354, such as in a vertical direction, to control movement of the CPA device 300 from the pre-stage position to the seated position. The CPA device 300 is in an elevated position in the pre-stage position. For example, the main body 310 is elevated above the top 224 of the outer housing 200. The electrical connector assembly 100 has a taller profile when the CPA device 300 is in the pre-stage position. With the taller profile, the electrical connector assembly 100 may be unable to fit through the opening 50 in the panel 60 (shown in FIG. 1), which provides a mechanical or visual indication to the installer that the electrical connector assembly 100 is not properly assembled.

In an exemplary embodiment, the latch blocking finger 326 is configured to block the first latch 240 when the CPA device 300 is in the seated position (FIG. 8). For example, the latch blocking finger 326 may be moved into alignment with and positioned behind the latch arm 242 of the first latch 240. The latch blocking finger 326 may be positioned between the latch arm 242 and the side 230 of the outer housing 200 to block actuation of the first latch 240 and thus block release of the first latch 240 from the first electrical connector 120.

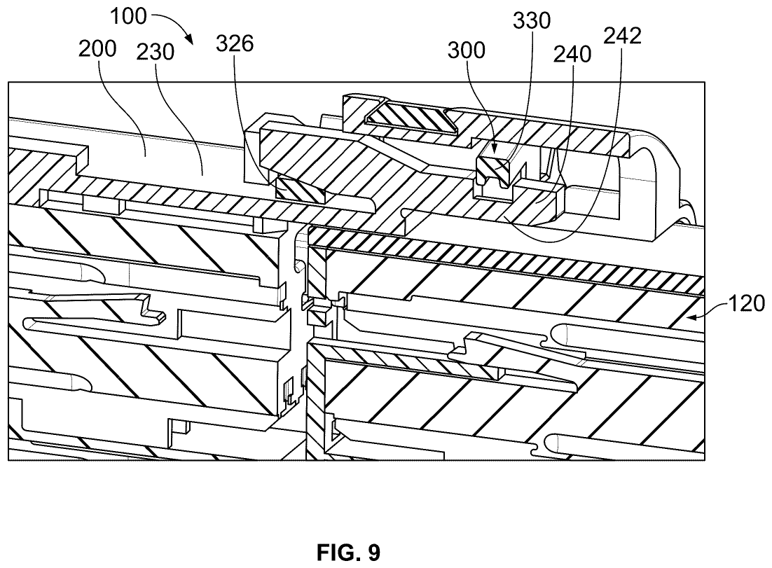

FIG. 9 is a cross-sectional view of a portion of the electrical connector assembly 100 showing the CPA device 300 in the seated position. In the seated position, the engagement feature 330 is in a clearance position and does not interface with the first latch 240. In the seated position, the latch blocking finger 326 is moved into alignment with and position behind the latch arm 242 of the first latch 240. The latch blocking finger 326 may be positioned between the latch arm 242 and the side 230 of the outer housing 200 to block actuation of the first latch 240 and thus block release of the first latch 240 from the first electrical connector 120.

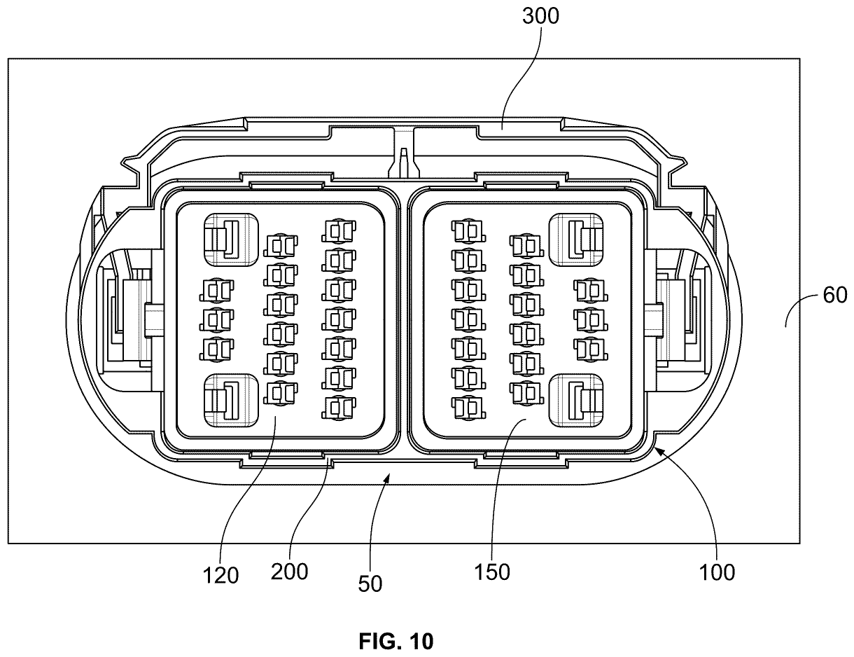

FIG. 10 is a front view of the electrical connector assembly 100 relative to the panel 60 and the opening 50 showing the CPA device 300 in the pre-stage position. In the pre-stage position, the CPA device 300 is elevated relative to the outer housing 200. The CPA device 300 increases the profile or outer perimeter of the electrical connector assembly 100. For example, with the CPA device 300 and the pre-stage position, the outer perimeter of the electrical connector assembly 100 may be larger than the opening 50 to prevent loading of the electrical connector assembly 100 through the opening 50. The CPA device 300 provides a visual confirmation to the installer that assembly is complete. For example, when the CPA device 300 is at an elevated position, this provides a clear visual indicator that the CPA device 300 is not fully engaged reducing the risk of incomplete connections during assembly and enhancing the overall system reliability. The installer is unable to install the electrical connector assembly 100 into the opening 50 when the CPA device 300 is in the pre-stage position. The CPA device 300 is designed so that the assembly will not fit through the opening 50 in the pre-stage position or in a partially engaged position. Only when the CPA device 300 is fully seated will the electrical connector assembly 100 pass through the opening 50. This design certifies to the installer that the first electrical connector 120 is fully mated, that the second electrical connector 150 is fully mated, and that the CPA device 300 is fully engaged. All three events can be certified with the use of the single CPA device 300 and without the need for providing multiple CPA devices or other assembly steps.

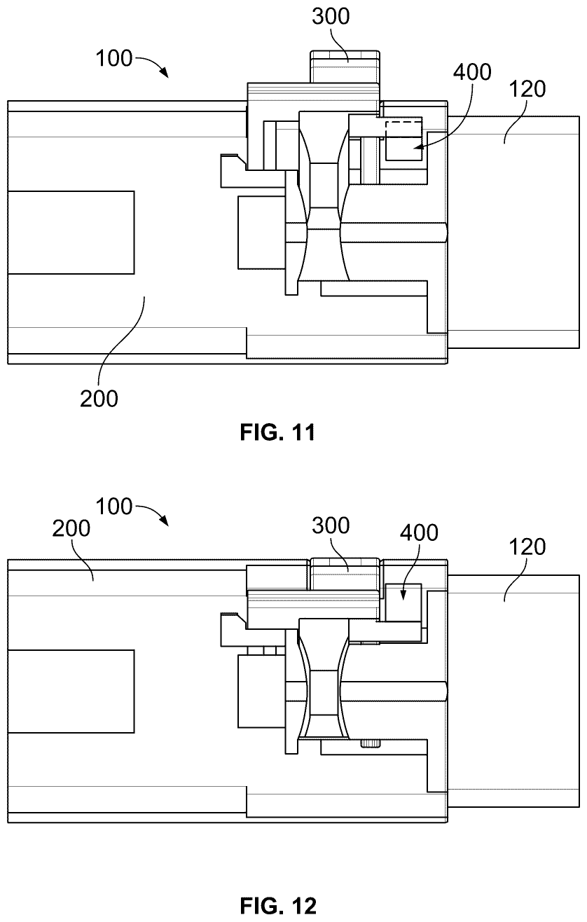

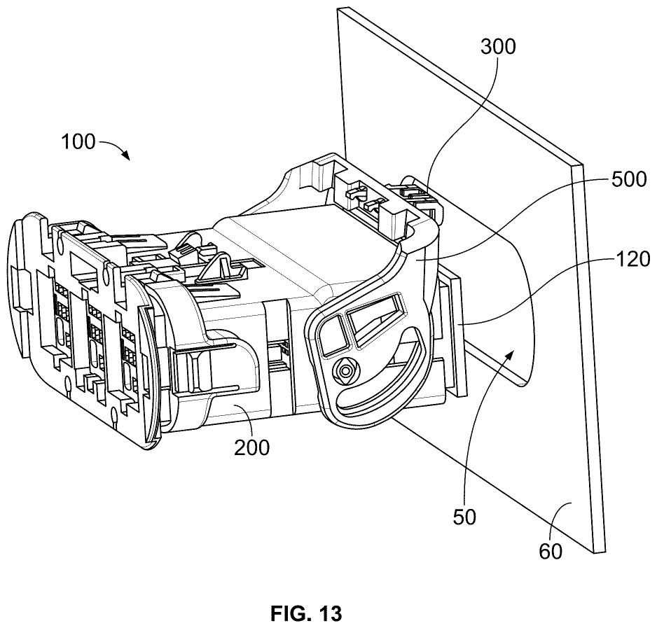

FIG. 11 is a side view of the electrical connector assembly 100 showing the CPA device 300 in the pre-stage position. FIG. 12 is a side view of the electrical connector assembly 100 showing the CPA device 300 in the seated position. In an exemplary embodiment, the electrical connector assembly 100 includes a scannable data matrix 400 on the outer housing 200. The scannable data matrix 400 is obscured and unscannable when the CPA device 300 is in the pre-stage position (FIG. 11). The scannable data matrix 400 is revealed and scannable when the CPA device 300 is in the seated position (FIG. 12). The scannable data matrix 400 provides a secondary indication to the installer that the connectors 120, 150 are fully mated and that the CPA device 300 is fully engaged reducing the risk of incomplete connections during assembly and enhancing the overall system reliability

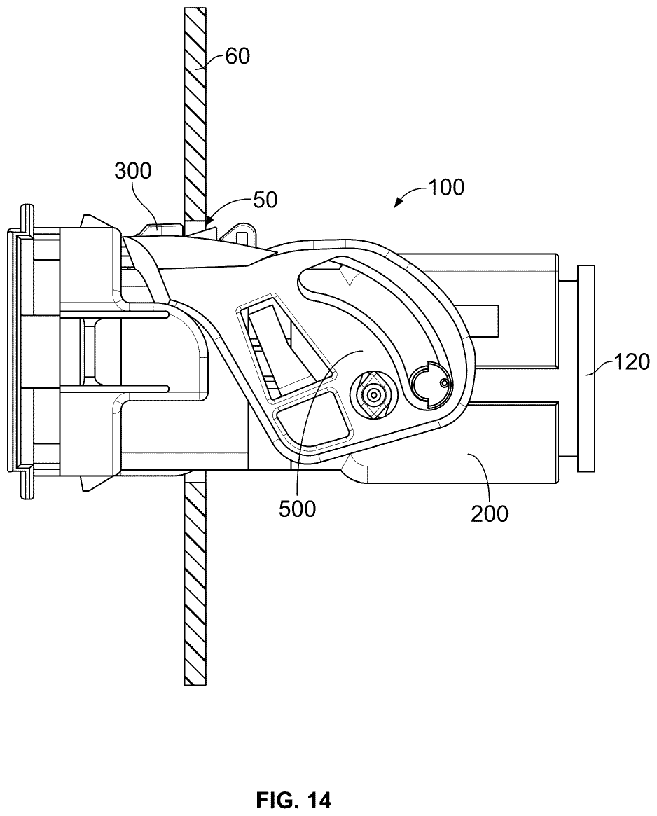

FIG. 13 is a perspective view of the electrical connector assembly 100 in accordance with an exemplary embodiment positioned relative to the opening 50 in the panel 60. FIG. 14 is a side view of the electrical connector assembly 100 in accordance with an exemplary embodiment partially loaded through the opening 50 in the panel 60. In the illustrated embodiment, the electrical connector assembly 100 includes a mechanical assist lever 500 to assist mating of the electrical connectors 120, 150. The CPA device 300 is provided on the mechanical assist lever 500. The mechanical assist lever 500 is rotatable relative to the outer housing 200 between an open position (FIG. 13) and a closed position (FIG. 14). Only when the mechanical assist lever 500 is in the closed position and the CPA device 300 is an actuated, seated position is the electrical connector assembly 100 sized to fit through the opening 50 in the panel 60. If the mechanical assist lever 500 is in the open position and/or the CPA device 300 is in the un-actuated or pre-stage position, the electrical connector assembly 100 has a profile that is sized too large to fit through the opening 50. Such a design ensures that the electrical connector assembly 100 is fully and properly assembled before the electrical connector assembly 100 may be coupled to the panel 60.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. An electrical connector assembly comprising:
a first electrical connector for mating with a first mating connector,
the first electrical connector including a first connector housing holding first contacts, the first electrical connector including a first latching element;
a second electrical connector for mating with a second mating connector, the second electrical connector including a second connector housing holding second contacts, the second electrical connector including a second latching element;
an outer housing including an outer wall surrounding a cavity, the outer housing including an inner wall dividing the cavity into a first connector chamber receiving the first electrical connector and a second connector chamber receiving the second electrical connector, the outer housing including a first latch at a first side of the outer housing and a second latch at a second side of the outer housing, the first latch configured to be operably coupled to the first latching element to secure the first electrical connector in the first connector chamber, the second latch configured to be operably coupled to the second latching element to secure the second electrical connector in the second chamber; and
a connector position assurance (CPA) device coupled to the outer housing, the CPA device movable between a pre-stage position and a seated position, the CPA device including a main body, a first CPA element configured to interface with the first latch and the first electrical connector, and a second CPA element configured to interface with the second latch and the second electrical connector, wherein movement of the CPA device into the seated position provides a mechanical indication that both the first and second electrical connectors are properly positioned within the outer housing and movement of the CPA device is prevented when at least one of the first and second electrical connectors are not fully inserted in the outer housing.

2. The electrical connector assembly of claim 1, wherein the CPA device is operable to provide position assurance for both the first and second electrical connectors.

3. The electrical connector assembly of claim 1, wherein the CPA device includes a connecting beam between the first and second CPA elements, the connecting beam spanning across both the first and second electrical connectors.

4. The electrical connector assembly of claim 3, wherein the CPA device includes a center blocking finger, the center blocking finger configured to interface with the first and second electrical connectors in the first and second connector cavities.

5. The electrical connector assembly of claim 1, wherein the first CPA element includes a first engagement feature configured to engage the first latch in the pre-stage position to interfere with movement of the first CPA element to the seated position unless the first electrical connector is properly seated within the outer housing, the second CPA element includes a second engagement feature configured to engage the second latch in the pre-stage position to interfere with movement of the second CPA element to the seated position unless the second electrical connector is properly seated within the outer housing.

6. The electrical connector assembly of claim 5, wherein the first latching element is configured to interface with the first engagement feature when the first electrical connector is fully seated within the outer housing to move the first engagement feature to a clearance position, the first CPA element is allowed to move from the pre-stage position to the seated position when the first engagement feature is in the clearance position, and wherein the second latching element is configured to interface with the second engagement feature when the second electrical connector is fully seated within the outer housing to move the second engagement feature to a clearance position, the second CPA element is allowed to move from the pre-stage position to the seated position when the second engagement feature is in the clearance position.

7. The electrical connector assembly of claim 6, wherein the first latch includes a first latch arm and a first latch window in the first latch arm, the first latch including a first latch finger, the first engagement feature of the first CPA element being received in the first latch window and engaging the first latch arm in an engagement position to block movement of the CPA element from the pre-stage position to the seated position when the first engagement feature is in the engagement position, the first latching element configured to be received in the first latch window to move the first engagement feature from the engagement position to the clearance position, the first latch finger being latchably coupled to the first latching element when the first electrical connector is fully seated within the outer housing, and wherein the second latch includes a second latch arm and a second latch window in the second latch arm, the second latch including a second latch finger, the second engagement feature of the second CPA element being received in the second latch window and engaging the second latch arm in an engagement position to block movement of the CPA element from the pre-stage position to the seated position when the second engagement feature is in the engagement position, the second latching element configured to be received in the second latch window to move the second engagement feature from the engagement position to the clearance position, the second latch finger being latchably coupled to the second latching element when the second electrical connector is fully seated within the outer housing.

8. The electrical connector assembly of claim 1, wherein the first CPA element includes a first guide finger engaging the outer housing to guide movement of the first CPA element relative to the outer housing, the second CPA element includes a second guide finger engaging the outer housing to guide movement of the second CPA element relative to the outer housing.

9. The electrical connector assembly of claim 1, wherein the first CPA element includes a latch blocking finger configured to engage the first latch and block actuation of the first latch when the CPA device is in the seated position, and wherein the second CPA element includes a latch blocking finger configured to engage the second latch and block actuation of the second latch when the CPA device is in the seated position.

10. The electrical connector assembly of claim 1, wherein the outer housing includes a scannable data matrix, the scannable data matrix being obscured and unscannable when the CPA device is in the pre-stage position, the scannable data matrix being revealed and scannable when the CPA device is in the seated position.

11. The electrical connector assembly of claim 1, wherein the outer housing includes a CPA pocket, the CPA device being received in the pocket in the seated position such that the CPA device fits within an outer profile of the outer housing in the seated position, the CPA device standing proud of the outer profile of the outer housing in the pre-stage position.

12. The electrical connector assembly of claim 11, wherein the outer housing is configured to be coupled to a panel, wherein the outer housing and the CPA device are configured to be received in and pass through an opening in a panel when the CPA device is in the seated position, and wherein the CPA device is configured to interfere with and is unable to pass through the opening when the CPA device is in the pre-stage position.

13. An electrical connector assembly configured to be coupled to a panel, the electrical connector assembly comprising:
a first electrical connector for mating with a first mating connector, the first electrical connector including a first connector housing holding first contacts, the first electrical connector including a first latching element;
a second electrical connector for mating with a second mating connector, the second electrical connector including a second connector housing holding second contacts, the second electrical connector including a second latching element;
an outer housing including an outer wall surrounding a cavity, the outer wall defining an outer profile, the outer housing including an inner wall dividing the cavity into a first connector chamber receiving the first electrical connector and a second connector chamber receiving the second electrical connector, the outer housing including a first latch at a first side of the outer housing and a second latch at a second side of the outer housing, the first latch configured to be operably coupled to the first latching element to secure the first electrical connector in the first connector chamber, the second latch configured to be operably coupled to the second latching element to secure the second electrical connector in the second chamber; and
a connector position assurance (CPA) device coupled to the outer housing, the CPA device movable between a pre-stage position and a seated position, the CPA device including a main body, a first CPA element configured to interface with the first latch and the first electrical connector, and a second CPA element configured to interface with the second latch and the second electrical connector, wherein movement of the CPA device into the seated position provides a mechanical indication that both the first and second electrical connectors are properly positioned within the outer housing and movement of the CPA device is prevented when at least one of the first and second electrical connectors are not fully inserted in the outer housing;
wherein the outer housing and the CPA device are configured to be received in and pass through an opening in a panel when the CPA device is in the seated position, and wherein the CPA device is configured to interfere with and is unable to pass through the opening when the CPA device is in the pre-stage position.

14. The electrical connector assembly of claim 13, wherein the outer housing includes a CPA pocket, the CPA device being received in the pocket in the seated position such that the CPA device fits within an outer profile of the outer housing in the seated position, the CPA device standing proud of the outer profile of the outer housing in the pre-stage position.

15. The electrical connector assembly of claim 13, wherein the CPA device is operable to provide position assurance for both the first and second electrical connectors.

16. The electrical connector assembly of claim 13, wherein the CPA device includes a connecting beam between the first and second CPA elements, the connecting beam spanning across both the first and second electrical connectors.

17. The electrical connector assembly of claim 13, wherein the first CPA element includes a first engagement feature configured to engage the first latch in the pre-stage position to interfere with movement of the first CPA element to the seated position unless the first electrical connector is properly seated within the outer housing, the second CPA element includes a second engagement feature configured to engage the second latch in the pre-stage position to interfere with movement of the second CPA element to the seated position unless the second electrical connector is properly seated within the outer housing.

18. The electrical connector assembly of claim 17, wherein the first latching element is configured to interface with the first engagement feature when the first electrical connector is fully seated within the outer housing to move the first engagement feature to a clearance position, the first CPA element is allowed to move from the pre-stage position to the seated position when the first engagement feature is in the clearance position, and wherein the second latching element is configured to interface with the second engagement feature when the second electrical connector is fully seated within the outer housing to move the second engagement feature to a clearance position, the second CPA element is allowed to move from the pre-stage position to the seated position when the second engagement feature is in the clearance position.

19. The electrical connector assembly of claim 18, wherein the first latch includes a first latch arm and a first latch window in the first latch arm, the first latch including a first latch finger, the first engagement feature of the first CPA element being received in the first latch window and engaging the first latch arm in an engagement position to block movement of the CPA element from the pre-stage position to the seated position when the first engagement feature is in the engagement position, the first latching element configured to be received in the first latch window to move the first engagement feature from the engagement position to the clearance position, the first latch finger being latchably coupled to the first latching element when the first electrical connector is fully seated within the outer housing, and wherein the second latch includes a second latch arm and a second latch window in the second latch arm, the second latch including a second latch finger, the second engagement feature of the second CPA element being received in the second latch window and engaging the second latch arm in an engagement position to block movement of the CPA element from the pre-stage position to the seated position when the second engagement feature is in the engagement position, the second latching element configured to be received in the second latch window to move the second engagement feature from the engagement position to the clearance position, the second latch finger being latchably coupled to the second latching element when the second electrical connector is fully seated within the outer housing.

20. An electrical connector assembly comprising:
a first electrical connector for mating with a first mating connector, the first electrical connector including a first connector housing holding first contacts, the first electrical connector including a first latching element;
a second electrical connector for mating with a second mating connector, the second electrical connector including a second connector housing holding second contacts, the second electrical connector including a second latching element;
an outer housing including an outer wall surrounding a cavity, the outer housing including an inner wall dividing the cavity into a first connector chamber receiving the first electrical connector and a second connector chamber receiving the second electrical connector, the outer housing including a first latch at a first side of the outer housing and a second latch at a second side of the outer housing, the first latch configured to be operably coupled to the first latching element to secure the first electrical connector in the first connector chamber, the second latch configured to be operably coupled to the second latching element to secure the second electrical connector in the second chamber; and
a connector position assurance (CPA) device coupled to the outer housing, the CPA device movable between a pre-stage position and a seated position, the CPA device including a main body, a first CPA element configured to interface with the first latch and the first electrical connector, and a second CPA element configured to interface with the second latch and the second electrical connector, wherein movement of the CPA device into the seated position provides a mechanical indication that both the first and second electrical connectors are properly positioned within the outer housing and movement of the CPA device is prevented when at least one of the first and second electrical connectors are not fully inserted in the outer housing;
wherein the outer housing includes a scannable data matrix, the scannable data matrix being obscured and unscannable when the CPA device is in the pre-stage position, the scannable data matrix being reveled and scannable when the CPA device is in the seated position.
